(19) United States
(12) Patent Application Publication
(10) Pub. No.: US 2019/0305705 A1
(43) Pub. Date: Oct. 3, 2019

(54) METHOD FOR SUPPLYING AN EXCITATION CURRENT TO AN EXCITATION WINDING OF A ROTOR, METHOD FOR OPERATING A SYSTEM FOR PRODUCING A THREE-PHASE ALTERNATING VOLTAGE, AND CORRESPONDING SYSTEM

(71) Applicant: Siemens Aktiengesellschaft, Munich (DE)

(72) Inventors: Martin Bennauer, Bottrop (DE); Manuel Gutermuth, Essen (DE); Christian Jäkel, Duisburg (DE); Meinolf Klocke, Witten (DE); Mario Koebe, Mülheim an der Ruhr (DE); Matthias Kowalski, Mülheim an der Ruhr (DE); Marian-Peter Pieczyk, Mülheim a.d. Ruhr (DE); Holger Romanowski, Duisburg (DE); Florian Röhr, Mülheim a.d. Ruhr (DE); Milan Schmahl, Mülheim an der Ruhr (DE); Christoph Lehmann, Neukirchen-Vluyn (DE); Pascal Piasecki, Gelsenkirchen (DE); Andrey Mashkin, Köln (DE); Kai Brune, Rheinberg (DE)

(73) Assignee: Siemens Aktiengesellschaft, Munich (DE)

(21) Appl. No.: 16/302,753

(22) PCT Filed: Apr. 21, 2017
(86) PCT No.: PCT/EP2017/059513

§ 371 Date: Nov. 19, 2018

(30) Foreign Application Priority Data
May 24, 2016 (EP) 16170952.2

(51) Int. Cl. H02P 9/42

(52) U.S. Cl. CPC H02P 9/42

(57) ABSTRACT

A method for supplying an excitation current to an excitation winding of a rotor of a three-phase generator of a system for producing a three-phase alternating voltage to be fed into a power network. A pulsed excitation current is supplied to the excitation winding if a rotational frequency of the rotor deviates from a network frequency of the power network.

### CROSS REFERENCE TO RELATED APPLICATIONS

This application is the US National Stage of International Application No. PCT/EP2017/059513 filed Apr. 21, 2017, and claims the benefit thereof. The International Application claims the benefit of European Application No. EP16170952 filed May 24, 2016. All of the applications are incorporated by reference herein in their entirety.

### FIELD OF INVENTION

The invention relates to a method for supplying a field current to a field winding of a rotor of a three-phase generator of an installation for generating a three-phase AC voltage to be fed into a power grid.

The invention furthermore relates to a method for operating an installation for generating a three-phase AC voltage to be fed into a power grid.

The invention further relates to an installation for generating a three-phase AC voltage to be fed into a power grid, having at least one turbine, at least one three-phase generator driven by way of the turbine, and at least one control and/or regulation unit controlling and/or regulating a supply of a field current to a field winding of a rotor of the three-phase generator, wherein a turbine rotor of the turbine is connected to the rotor in a rotationally fixed manner.

### BACKGROUND OF INVENTION

Installations for generating a three-phase AC voltage to be fed into a power grid are well known and are used in power plants. An installation of this kind can have at least one turbine and at least one three-phase generator, in particular a turbogenerator, which is driven by way of the turbine. The turbine may be, for example, a gas turbine of a combined cycle gas turbine (CCGT) power plant or of a gas turbine plant or a steam turbine of a steam turbine power plant.

A turbine rotor of the turbine is usually connected to a rotor of the three-phase generator in a rigid or rotationally fixed manner. In order to be able to use the three-phase generator to generate a three-phase AC voltage at a conventional grid frequency of 50 Hz or 60 Hz through rotation of the turbine rotor and to feed said three-phase AC voltage into a power grid, the turbine rotor therefore usually has to rotate at an operating frequency of 50 Hz or 60 Hz.

When such an installation starts up, the installation requires a certain time after a rotational frequency that is synchronous with the grid frequency of the power grid has been reached in order to be able to balance a possible phase shift between the grid frequency and the rotational frequency. This time is not available for an infeed of the three-phase AC voltage generated by the installation into the power grid.

When the installation starts up in this way, the rotational speed of the turbine rotor or of the rotor can be accelerated, for example, to 3000 rpm. In this case, a magnetic field rotating at 3000 rpm is conventionally generated between the rotor and a stator of the three-phase generator owing to a field current formed as a direct current, which field current is supplied to the field winding of the rotor. Said magnetic field induces in a stator winding of the stator a three-phase AC voltage at a frequency corresponding to the respective grid frequency, for example of 50 Hz. After balancing of possible phase shifts as described above, a generator switch can interconnect the three-phase generator and the power grid. The turbine rotor and the rotor then run synchronously with the power grid. The installation takes up load and feeds the three-phase AC voltage into the power grid.

In specific cases, in particular when such an installation is operated in a frequency back-up operation, the rotational speed of the turbine rotor or of the rotor is matched to the grid frequency. In this case, the installation attempts to retain the grid frequency in order to stabilize the power grid by counteraction, in particular by variation of the rotational speed. For an installation of this kind, only one specific frequency range in which a described frequency back-up operation is possible is enabled for reasons of rotor dynamics and for reasons of stability of a compressor of the turbine, in particular gas turbine.

### SUMMARY OF INVENTION

It is an object of the invention to increase the utilization capacity of an installation for generating a three-phase AC voltage to be fed into a power grid. It is a further object of the invention to make it possible to use turbines of corresponding installations whose turbine rotor rotational frequency is lower than the grid frequency of the respective power grid in order to supply a three-phase AC voltage at the grid frequency to the power grid. It is a further object of the invention to improve a frequency back-up operation of a corresponding installation.

According to a method according to the invention for supplying a field current to a field winding of a rotor of a three-phase generator of an installation for generating a three-phase AC voltage to be fed into a power grid, a pulsed field current is supplied to the field winding when a rotational frequency of the rotor deviates from a grid frequency of the power grid.

According to the invention, deviations of the rotational speed of the rotor of the three-phase generator from the grid frequency of the power grid are balanced by supplying a pulsed field current to the field winding of the rotor. As a result thereof, a three-phase AC voltage at the grid frequency can be generated by means of the three-phase generator, even when the rotational frequency of the rotor differs from the grid frequency. It is therefore not necessary, as is conventional, for the rotational speed of the turbine rotor or of the rotor connected thereto in a rotationally fixed manner to be varied in order to be able to match the frequency of the three-phase AC voltage generated by the three-phase generator to the grid frequency. Instead, the installation, or the component parts thereof such as the turbine and the three-phase generator, can be dimensioned for an optimum operating point and be kept at the operating point during the mentioned adjustment, which increases the efficiency of the installation overall.

If, for example, the rotational frequency of the rotor is lower than the respective grid frequency, a pulsed field current can be supplied to the field winding. As a result thereof, a magnetic field that rotates at a frequency corresponding to the grid frequency is generated between the rotor and a stator of the three-phase generator. A stator winding of the stator thus sees a magnetic field that rotates at the frequency corresponding to the grid frequency, as a result of which an AC voltage at the grid frequency is induced in the stator winding.

As a result thereof, a three-phase AC voltage at a frequency corresponding to the grid frequency can be generated in the stator even during start-up of the installation or at an earlier time. Synchronization can therefore take place between the three-phase AC voltage and the power grid even at a very early time during the start-up of the installation, as a result of which the time required for this synchronization can be shortened significantly. The synchronization can thus take place as early as at a time at which the rotational frequency of the rotor does not correspond to the grid frequency. As a consequence, this significantly increases the utilization capacity of the installation compared to a conventional installation, as is described at the outset. After the synchronization, a direct current can be supplied to the field winding. Owing to the earlier synchronization, the installation can provide electrical power to the power grid significantly earlier compared to a conventional installation.

Since the power and the efficiency of gas turbines at an operating frequency of 50 Hz (50 Hz gas turbines) are greater than in the case of corresponding 60 Hz gas turbines, there is an interest in also using 50 Hz gas turbines to supply power to power grids at a grid frequency of 60 Hz (60 Hz power grids).

By supplying a pulsed field current to the field winding of the rotor, a rotating magnetic field whose rotational frequency is greater than the rotational frequency of the rotor and a further rotating magnetic field whose rotational frequency is lower than the rotational frequency of the rotor can be formed between the stator and the rotor. Given a rotational frequency of the rotor, for example, of 50 Hz, a magnetic field rotating at a rotational frequency of 60 Hz and a magnetic field rotating at a rotational frequency of 40 Hz can be formed through suitable selection of the pulsed field current. This results in an AC voltage at a frequency of 60 Hz and an AC voltage at a frequency of 40 Hz being induced in the stator winding. The 40 Hz AC voltage can be filtered out of the three-phase AC voltage generated by way of the three-phase generator by way of a suitable means so that a 60 Hz three-phase AC voltage is applied to a machine transformer, by means of which the three-phase generator is connected to the power grid, in order to be able to provide said voltage with corresponding power to the power grid. Consequently, it is possible to use the method according to the invention to feed a three-phase AC voltage at the grid frequency into the power grid by way of a turbine whose turbine rotor rotational frequency is lower than the grid frequency of the power grid. A higher specific power can be achieved as a result.

By supplying a pulsed field current to the field winding of the rotor, the stator winding of the stator can thus see a magnetic field that rotates at the grid frequency. Through suitable selection of the pulsed field current, a frequency back-up by the installation independently of the rotational frequency of the rotor can be ensured as a result. In particular, the installation can provide frequency back-up in a much wider frequency range than conventional installations. The dimensioning of the component parts of the installation does not have to be such that the component parts of the installation have to be able to satisfy a specific frequency back-up range. Instead, the component parts can be dimensioned to a specific operating point at which, in particular, the installation has a high efficiency and a high durability. It is thus possible to provide an installation with an improved frequency back-up operation.

The pulsed field current is advantageously generated in such a way that a frequency of the pulsed field current corresponds to a difference frequency resulting from a subtraction of the rotational frequency from the grid frequency. The pulsed field current is hereafter generated depending on the respective rotational frequency.

The pulsed field current is advantageously generated in such a way that it has a sinusoidal, square-wave, triangular or sawtooth profile over time. As a result thereof, the pulsed field current can be optimally matched to the respective case of application. It may also be possible for the shape of the profile of the pulsed field current to be varied during supply of the pulsed field current to the field winding.

The pulsed field current is advantageously generated in such a way that a 60 Hz rotating magnetic field and a 40 Hz rotating magnetic field rotating in the opposite direction thereto are generated between the rotor and a stator of the three-phase generator. As a result thereof, a 60 Hz AC voltage and a 40 Hz AC voltage are generated in the stator winding of the stator. Said 40 Hz AC voltage can be filtered out of a three-phase AC voltage generated by the three-phase generator so that a 60 Hz three-phase AC voltage can be provided to a 60 Hz power grid. This makes it possible, in particular, to use a 50 Hz turbine, for example a 50 Hz gas turbine, to generate a 60 Hz three-phase AC voltage.

According to a method according to the invention for operating an installation for generating a three-phase AC voltage to be fed into a power grid, a pulsed field current is supplied to a field winding of a rotor of a three-phase generator of the installation using a method in accordance with one of the aforementioned refinements, or any desired combination of at least two of said refinements with one another, wherein voltage components of a three-phase AC voltage generated by a stator winding of the stator that deviate from the grid frequency are filtered out of the three-phase AC voltage.

The advantages mentioned above with reference to the method for supplying a field current to a field winding of a rotor of a three-phase generator of an installation for generating a three-phase AC voltage are correspondingly associated with this method.

The pulsed field current also generates in the stator winding an AC voltage whose frequency corresponds to a difference frequency that corresponds to a subtraction of the frequency of the pulsed field current from the rotational frequency of the rotor. This voltage component is filtered out of the three-phase AC voltage generated by way of the three-phase generator by way of suitable means. As an alternative, a voltage component generated in another way can be filtered out of the three-phase current.

The voltage components are advantageously filtered out of the three-phase AC voltage by way of at least one frequency filter or at least one series resonant circuit. The frequency filter can have a series resonant circuit for each phase of the generated three-phase AC voltage.

An installation according to the invention for generating a three-phase AC voltage to be fed into a power grid comprises at least one turbine, at least one three-phase generator driven by way of the turbine, and at least one control and/or regulation unit controlling and/or regulating a supply of a field current to a field winding of a rotor of the three-phase generator. A turbine rotor of the turbine is connected to the rotor in a rotationally fixed manner. The control and/or regulation unit is configured to supply a pulsed field current to the field winding when a rotational frequency of the rotor deviates from a grid frequency of the power grid.

The advantages mentioned above with reference to the methods are correspondingly associated with the installation. In particular, the installation can be used to carry out said methods.

The turbine can be a gas turbine or a steam turbine. In particular, the turbine can be a 50 Hz or 60 Hz gas turbine or a 50 Hz or 60 Hz steam turbine. The three-phase generator can be designed in a conventional manner. The control and/or regulation unit can be formed by a part of an installation electronics system or separately therefrom. The control and/or regulation unit can comprise a computation unit and a storage unit.

The control and/or regulation unit is advantageously configured to subtract the rotational frequency from the grid frequency and to determine a difference frequency resulting therefrom as a frequency of the pulsed field current. The advantages mentioned above with reference to the corresponding refinement of the method mentioned first are correspondingly associated with this refinement.

The installation advantageously comprises at least one frequency filter or at least one series resonant circuit, by way of which voltage components of a voltage generated by a stator winding of a stator of the three-phase generator that deviate from the grid frequency can be filtered out of the voltage. The advantages mentioned above with reference to the corresponding refinements of the method mentioned second are correspondingly associated with this refinement.

### BRIEF DESCRIPTION OF THE DRAWINGS

The invention is explained by way of example below on the basis of embodiments with reference to the accompanying figures, wherein the features presented below, either in each case by themselves or in various combinations with one another, can constitute one aspect of the invention. In the figures:

FIG. 1 shows a schematic illustration of an exemplary embodiment of an installation according to the invention;

FIG. 2 shows a schematic longitudinal section of a three-phase generator of an exemplary embodiment of an installation according to the invention; and

FIG. 3 shows a schematic cross section of the three-phase generator shown in FIG. 2.

### DETAILED DESCRIPTION OF INVENTION

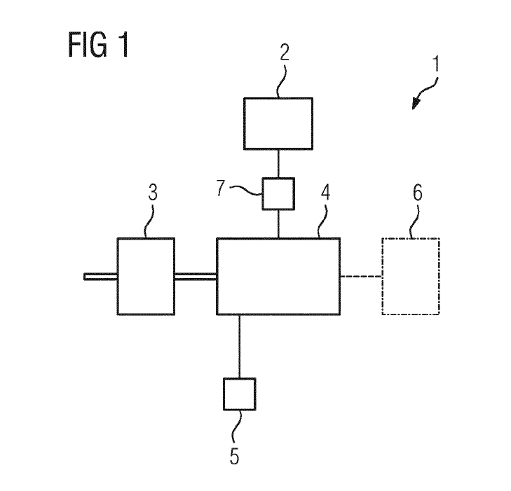

FIG. 1 shows a schematic illustration of an exemplary embodiment of an installation 1 according to the invention for generating a three-phase AC voltage to be fed into a power grid 2.

The installation 1 comprises a turbine 3 in the form of a gas turbine, a three-phase generator 4 driven by way of the turbine 3, and a control and/or regulation unit 5 controlling and/or regulating a supply of a field current to a field winding (not shown) of a rotor (not shown) of the three-phase generator 4. A turbine rotor (not shown) of the turbine 3 is connected to the rotor in a rotationally fixed manner. As an alternative, the installation 1 can have at least one steam turbine 6 instead of the turbine 3, by way of which steam turbine the rotor of the three-phase generator 4 can be driven.

The control and/or regulation unit 5 is configured to supply a pulsed field current to the field winding when a rotational frequency of the rotor deviates from a grid frequency of the power grid 2. To this end, the control and/or regulation unit 5 can have a pulsation modulator.

In particular, the control and/or regulation unit 5 is configured to subtract the rotational frequency from the grid frequency and to determine a difference frequency resulting therefrom as a frequency of the pulsed field current. The control and/or regulation unit 5 therefore generates the pulsed field current depending on said difference frequency. The pulsed field current can have a sinusoidal, square-wave, triangular or sawtooth profile over time.

The installation 1 also comprises a frequency filter 7 or at least one series resonant circuit (not shown), by way of which voltage components of a three-phase AC voltage generated by a stator winding (not shown) of a stator (not shown) of the three-phase generator 4 that deviate from the grid frequency can be filtered out of the three-phase AC voltage.

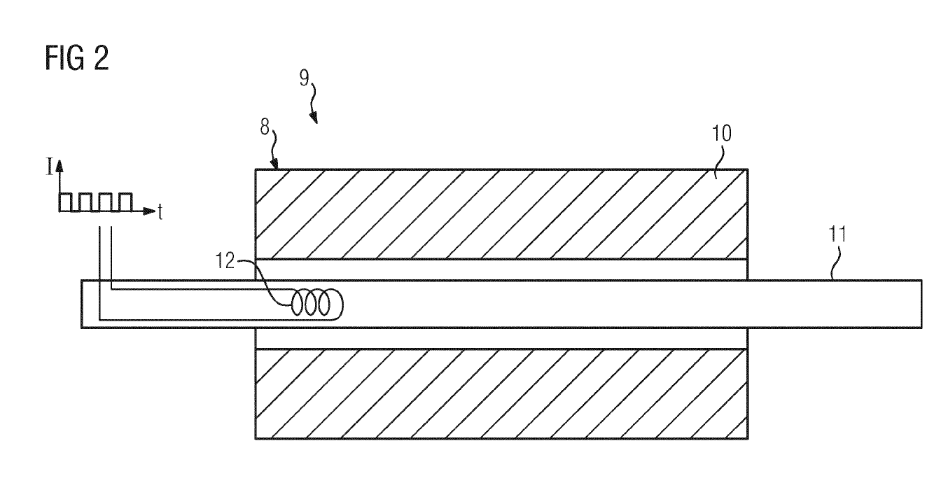

FIG. 2 shows a schematic longitudinal section of a three-phase generator 8 of an exemplary embodiment of an installation 9 according to the invention.

The three-phase generator 8 comprises a stator 10, which has a laminated stack (not illustrated in more detail) and a stator winding (not shown) arranged thereon. The three-phase generator 8 furthermore comprises a rotor 11 having a field winding 12, to which a pulsed field current I having a square-wave profile over time t is supplied.

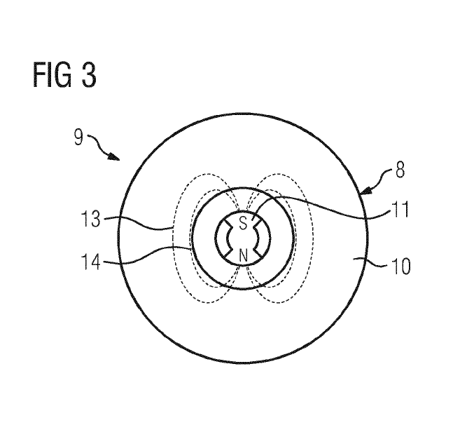

FIG. 3 shows a schematic cross section of the three-phase generator 8 shown in FIG. 2. The rotor 11 comprises the magnetic poles N (north pole) and S (south pole). Field lines of two rotating magnetic fields 13 and 14 are indicated by dashed lines, which field lines are produced by the supply of the pulsed field current to the field winding (not shown) of the rotor 11. The rotational frequencies of the two rotating magnetic fields 13 and 14 can be selected in such a way that a sum of the two rotational frequencies corresponds to the respective grid frequency of the power grid (not shown).

Although the invention has been illustrated and described in more detail by way of the exemplary embodiments, the invention is not restricted in this way by the examples disclosed and other variations can be derived therefrom by the person skilled in the art, without departing from the scope of protection of the invention.

1. A method for supplying a field current to a field winding of a rotor of a three-phase generator of an installation for generating a three-phase AC voltage to be fed into a power grid, the method comprising:
supplying a pulsed field current to the field winding when a rotational frequency of the rotor deviates from a grid frequency of the power grid.

2. The method as claimed in claim 1,
wherein the pulsed field current is generated in such a way that a frequency of the pulsed field current corresponds to a difference frequency resulting from a subtraction of the rotational frequency from the grid frequency.

3. The method as claimed in claim 1,
wherein the pulsed field current is generated in such a way that the pulsed field current has a sinusoidal, square-wave, triangular or sawtooth profile over time.

4. The method as claimed in claim 1,
wherein the pulsed field current is generated in such a way that a 60 Hz rotating magnetic field and a 40 Hz rotating magnetic field rotating in the opposite direction thereto are generated between the rotor and a stator of the three-phase generator.

5. A method for operating an installation for generating a three-phase AC voltage to be fed into a power grid, the method comprising:
supplying a pulsed field current to a field winding of a rotor of a three-phase generator of the installation using a method as claimed in claim 1, and
filtering voltage components out of a three-phase AC voltage generated by a stator winding of the stator that deviate from the grid frequency.

6. The method as claimed in claim 5,
wherein the voltage components are filtered out of the three-phase AC voltage by way of at least one frequency filter or at least one series resonant circuit.

7. An installation for generating a three-phase AC voltage to be fed into a power grid, comprising:
at least one turbine,
at least one three-phase generator driven by way of the turbine, and
at least one control and/or regulation unit controlling and/or regulating a supply of a field current to a field winding of a rotor of the three-phase generator,
wherein a turbine rotor of the turbine is connected to the rotor in a rotationally fixed manner,
wherein the control and/or regulation unit is configured to supply a pulsed field current to the field winding when a rotational frequency of the rotor deviates from a grid frequency of the power grid.

8. The installation as claimed in claim 7,
wherein the control and/or regulation unit is configured to subtract the rotational frequency from the grid frequency and to determine a difference frequency resulting therefrom as a frequency of the pulsed field current.

9. The installation as claimed in claim 7, further comprising:
at least one frequency filter or at least one series resonant circuit, by way of which voltage components of a three-phase AC voltage generated by a stator winding of a stator of the three-phase generator that deviate from the grid frequency can be filtered out of the three-phase AC voltage.

10. The method as claimed in claim 1, further comprising:
determining when a rotational frequency of the rotor deviates from a grid frequency of the power grid.

11. The method as claimed in claim 1, further comprising:
feeding the generated three-phase AC voltage into a power grid.
